(19) United States
(12) Patent Application Publication
(10) Pub. No.: US 2025/0037281 A1
(43) Pub. Date: Jan. 30, 2025

(54) SYSTEM AND METHOD FOR EVALUATION OF IMAGE QUALITY

(71) Applicant: VOLPARA HEALTH TECHNOLOGIES LIMITED, Wellington (NZ)

(72) Inventors: Ralph HIGHNAM, Wellington (NZ); Melissa HILL, Issy les Moulineaux (FR); Kaier WANG, Lower Hutt (NZ)

(21) Appl. No.: 18/714,065

(22) PCT Filed: Nov. 29, 2022
(86) PCT No.: PCT/IB2022/061523

§ 371 Date: May 28, 2024

(30) Foreign Application Priority Data
Nov. 29, 2021 (GB) 2117222.6

(51) Int. Cl. G06T 7/00; G06T 7/11; G06T 7/33; G06V 10/764

(52) U.S. Cl. CPC G06T 7/0014; G06T 7/11; G06T 7/33; G06V 10/764; G06T 2207/30068; G06T 2207/30168; G06V 2201/03

(57) ABSTRACT

A system and method are disclosed for quantitative evaluation of image acquisition quality within a field of view and derivation of associated qualitative metrics to inform interpretation. The medical image evaluation system comprises: a data input device to acquire data of medical images: and a data processor to perform an image segmentation on one or more of the medical image(s) of a body portion to delineate tissue(s) of interest from a surrounding region within a field of view. The data processor is configured to resolve any missing tissue which is any portion of the tissue(s) of interest missing from the image segmentation. The data processor is configured to quantify suitability of the medical images for interpretation by making an estimate of amount or location of the missing tissue. A data device is configured to advise a user of the quantified suitability of the medical images for interpretation.

### FIELD

The present invention relates to a system and method for quantitative evaluation of image quality within a field of view and derivation of associated qualitative metrics to inform interpretation of a medical image.

### BACKGROUND

Medical images are acquired to assist practitioners. Medical images may target a tissue of interest. The tissue of interest may include an organ tissue such as a lung, breast, heart, liver and so forth, or a particular type of tissue within an organ such as parenchymal tissue. The tissue of interest may include a body part such as a particular bone such as a rib, vertebrae, artery, or nerve which may obscure or obstruct a view of another tissue of interest. The tissue of interest may include a tumour tissue or etiology in a body organ or body part.

Comprehensive interpretation can only be made from a medical image if the tissue of interest, which may comprise one or more features of prognostic importance, is visible in the medical image. Thus, the amount of the tissue of interest visible within the field of view (FOV) is a critical determinant of the clinical utility of that image.

Assuming that there has been appropriate selection of the imaging modality for the purpose, there are three imaging factors that determine the visibility of the tissue of interest.

A first of the imaging factors is that the tissue must be present within the FOV. Tissue of interest that is not within the field of view can be said to be ‘missing’ since it is otherwise expected to be visible within the FOV. We refer herein to the adequacy of relevant tissue in an image as ‘tissue sufficiency.’

A second of the imaging factors is that the tissue of interest must be unobstructed from view. If sufficient tissue of interest is present in the FOV, but is obstructed from view, then a prognosis similarly can often not be made from the image. When tissue, or other image features, are obstructed from view it means that these features are nominally present within the imaging FOV, but they cannot be clearly distinguished.

Causes of obstruction of a tissue include: superposition of image signal, whose source may be from nearby native tissues (i.e., tissues local to the organ and/or part of the patient's body), from one or more foreign objects (i.e., items that are not native to the body such as jewelry, medical devices, etc.), or from image artefacts. Image artefacts are image features that do not directly represent properties of the imaged subject and that detract from image interpretation, for example. distracting attention away from the relevant features or alternatively by obscuring or mimicking image features important for interpretation.

A third of the imaging factors is technical details of image quality. The technical details may include the image contrast, noise levels, and sharpness which must be adequate in the interpreted version of the image so as to not obscure the tissue of interest. For example, poor selection of technical image acquisition parameters could result in insufficient contrast between tissue of interest, which is not otherwise obstructed, and adjacent material such that a boundary between the two may be obscured.

Another consideration for evaluation of medical image quality is temporal development. Causes of obstruction may change as the system or patient ages. The tissue of interest may change in size, position, and density over time. The technical details may differ over time. Earlier images may be acquired by one system and later images may be acquired by another system. Relationships may be stochastic or probabilistic over time.

To obtain the processed image, ‘raw’ digital medical images may be processed by vendor-specific software in some way, for what is intended to be superior visual assessment compared to the unprocessed, ‘raw,’ image format. Such processing may include volumetric image reconstruction, noise reduction, sharpness enhancement, artefact suppression, contrast enhancement, or any combination thereof. However, sometimes the image processing introduces artefacts, noise, or manipulates the contrast in a way that alters perception of some image features.

Accurate interpretation is dependent upon the three separate imaging factors temporal developments that determine whether there is: tissue sufficiency, an unobstructed view, and adequate technical factors of image quality.

Whether or not the tissue of interest is successfully located in the imaging FOV is usually related to some combination of the quality of patient positioning for the exam, patient body habitus, and patient compliance. The imaging technologist acquiring the exam and/or interpreting physician are usually responsible for visually evaluating tissue sufficiency in a qualitative manner. Similarly, in a well selected imaging exam, having an unobscured, or direct, view of the tissue of interest is often related to the same factors of patient positioning, patient body habitus, and patient compliance. This aspect of image quality is typically assessed by a combination of the imaging technologist and interpreting physician in a visual and subjective manner.

Although the imaging system technical image quality factors are typically rigorously monitored through objective and routine quality control programs, these programs usually do not directly assess aspects of the technical quality of the clinical images themselves, which is left to a visual and subjective interpretation. Ultimately, subjective evaluation of image quality is done for each of these factors due to the complexity of, and interplay between, clinical imaging variables. Sources of complexity include variable patient anatomy, patient-specific positioning or views, the particular acquisition parameters/protocol, and vendor-specific image reconstruction and/or processing applied before display.

Practice guidelines and/or standards usually exist to describe required and desired elements of image quality. Most widely accepted image quality standards provide a series of statements to help guide clinicians in deciding if an image is adequate for assessment. In most cases the statements specify important anatomical structures that should be visible and may provide classifications for the degree of visibility. The interpretation of these statements relies on expertise and training as they are typically quite subjective. Furthermore, the criteria are often inconsistent globally, which can lead to variability in standards of care.

Automated clinical image quality assessment algorithms have emerged to make the process more efficient and reduce subjectivity. For example, such algorithms have been reported in mammography, chest radiography, and thoracic CT and largely focus on patient positioning. However, these methods simply automate the manual positioning assessment, which doesn't address the limitations of the criteria themselves.

Nor do such methods evaluate the visibility of the tissue of interest, predict amounts of missing tissue, or estimate the implications of the quality and quantity of imaged tissue on interpretation.

The criteria based on anatomical feature visibility are limited because they are largely surrogate indicators for tissue sufficiency based on generic reference landmarks that are estimated to be representative of tissue inclusion in the FOV. Direct measurements of tissue sufficiency are not made and few aspects of the visibility of the imaged tissue are addressed. Due to the complexities for interpretation of image quality, including those described above, a comprehensive evaluation of the visibility of the tissue of interest has been left to visual assessment.

Obscuration impedes perception and can be anywhere from complete (i.e., occluded) to partial. Estimates of the degree of obscuration can be useful to predict the potential of an image, or imaging exam, for interpretation.

Furthermore, the quantity of a specific tissue type that is visible may be important for risk assessment. Visibility of tissue in an image is a critical factor across imaging modalities and clinical applications.

For example, a chest radiography exam typically includes posteroanterior (PA) and latero-lateral (LL) projections with the patient standing. It has been suggested that the LL view may not be required, however the PA view has been estimated to have an unobstructed field of view that represents just less than 75% of the total lung volume and 57% of the total lung area, otherwise the view is obstructed by the superimposed anatomical structures such as thoracic spine, mediastinum, heart, diaphragm, and blood vessels. Missed findings on chest radiographs are often related to such superimposed structures. As such, an estimate of the degree of obstruction could be useful in chest radiography to predict the potential of any one view for prognosis. This would suggest whether additional views would add valuable information.

In volumetric imaging techniques, such as CT and MRI, any portion of the patient outside of the FOV can cause artefacts within the FOV due to the incomplete information available for volumetric image reconstruction. These artefacts have the potential to obstruct an important finding. Measurement of the degree of obstruction by the artefacts, or other objects/tissues would be valuable to estimate the visibility of the imaged portion of the tissue of interest and the resulting potential of the exam to reveal an important finding.

Furthermore, the tissue that was outside of the FOV may be important for to discover an important finding. Disease may have been present in the tissue outside the FOV, or the missing tissue may have been important to quantify for other purposes, such as measurements of tissue path lengths and compositions that are used for attenuation corrections in positron emission tomography (PET)/CT.

Mammography, where x-rays are used to examine the breast as a screening and detection mechanism for breast cancer, provides a particularly good example of a modality where tissue visibility is of high importance. In mammography, portions of the breast tissue may be difficult to include in the FOV, or to image without superimposing structures, due to any combination of patient habitus, limitations of the imaging system geometry, and inadequate positioning technique. This is a well-known problem as it is a relatively frequent cause for missed cancers in mammographic screening.

To prevent missed cancers and to maximize the potential for accuracy of interpretation, a variety of mammographic positioning rules have been established. Firstly, two projection views; the craniocaudal (CC) and mediolateral oblique (MLO), are acquired in most screening programs to ensure as much breast tissue as possible has been captured on the image and to allow for improved localization within the breast using triangulation.

Secondly, an assessment of breast positioning and image quality is conducted against a set of image quality criteria. Two commonly accepted standards involve grouping studies into categories according to their quality level, such as Perfect, Good, Moderate, Inadequate (PGMI) or Excellent Adequate Repeat (EAR). However, the positioning rules are general and were likely developed because they apply well to the majority of breasts. But since each woman's anatomy is individual, these indirect, general rules, may not be good indications of whether tissue has been visualised. For example, several positioning criteria are highly reliant on landmarks within the breast, such as the pectoral muscle being present, which is difficult to achieve for certain patients. Assessment of optimal positioning in the CC view is made worse by the lack of landmarks in this view. In many standards there is a reliance on comparison of the CC to the MLO, which is ineffective if the MLO itself is sub-optimally positioned.

For subsequent screening rounds there is a heavy reliance on comparison with prior mammograms to estimate the maximum tissue visualisation possible for an individual patient. Although, quantitative measurements are sometimes made on small sample sizes to obtain quantitative measures, the comparisons of CC to MLO are typically not made quantitatively. and there is a risk that the follow up mammograms were acquired with the aim to reproduce a prior mammogram that was sub-optimal. A person evaluating the medical image(s) may be confounded by a temporal development in an etiology or quantitative tissue density or breast density.

Additionally, an important biomarker of women's health status derived from mammograms is breast density, or the proportion of glandular and connective tissues in the breast relative to the total amount of breast tissue. Estimates of breast density, including volumetric breast density (VBD), have been shown to be useful predictors of a woman's risk of developing breast cancer, and also for the efficacy of mammographic screening, which is limited for women in the highest breast density categories. Accurate estimates of breast density rely on the inclusion of as much breast tissue in the FOV as possible and minimal obstructions, especially image artefacts, which could interfere with tissue quantification.

Predictions of the amounts of missing tissue would help inform estimates of uncertainty in breast density measurements and the critical derived quantities such as breast cancer risk. Objective, personalised, quantitative, and direct assessments of breast tissue visibility would help to make useful predictions of the implications of image quality for image assessment.

As interest grows in the use of artificial intelligence (AI) in medical imaging, various detection support algorithms are being adopted to increase efficiencies by analysing images and providing assessments before a radiologist has reviewed the image. As with clinicians, the uncertainty of assessment from Al would increase for studies with inadequate image quality. For image analysis Al to be fully trusted, the Al would ideally first assess if the tissue is adequately visualised and that the mammogram is suitable for assessment.

Additionally, one proposed AI application is computer-aided detection (CAD) for incidental findings. In this case, ‘incidental findings’ refers to findings that are not related to the feature of primary interest that likely led to the imaging exam requisition. This application is inspired by the fact that it may be possible to detect signs of disease for an etiology, a tissue type, or an organ that was not otherwise of interest to the physician ordering the exam, but that happens to be present in the image. It is easy for a reader to miss, or overlook, a sign of disease simply because they were reading the examination with the intent of a search for a different, and often very particular imaging feature. Nonetheless, it is rarely justified to have multiple different imaging specialists review an exam, for disparate disease etiologies. Hence the promise for AI-CAD to serve the role as an ‘expert reader’ that has the knowledge across multiple subspecialities, and that is not limited by the feature-specific focus required by the visual search process. However, application of CAD for detection of incidental findings requires information about what anatomy is in the FOV, and importantly, information about what portion of anatomy may not be in the FOV for reliable application.

In the case of incidental findings, it is quite likely the patient may not have been adequately positioned for the imaging procedure to capture the extent of anatomy of incidental interest.

It would be of value to have objective and comprehensive means to assess the sufficiency of visible tissue of interest in a medical image or ensemble of images and to predict missing tissue to improve the adequacy of interpretation and, or prognostic efficacy.

### SUMMARY OF THE INVENTION

According to a first aspect of the invention there is a medical image evaluation method comprising: acquiring data of one or more medical image(s) of a body portion; performing an image segmentation on the medical image(s) to delineate tissue(s) of interest from a surrounding region within a field of view; resolving any missing tissue which is any portion of the tissue(s) of interest missing from the image segmentation; and resolving from the missing tissue, suitability of the medical image(s) for interpretation.

The interpretation may be weighted by a combination of the amount, location, or type of the missing tissue.

The tissues of interest that are missing may be not visible in any segmented region. However the tissues of interest that are missing may be otherwise perceptible.

According to a second aspect of the invention there is a medical image evaluation system comprising: a data input device to acquire data of medical images; a data processor to perform an image segmentation on one or more of the medical image(s) of a body portion to delineate tissue(s) of interest from a surrounding region within a field of view; the data processor to resolve any missing tissue which is any portion of the tissue(s) of interest missing from the image segmentation; the data processor to resolve, from the missing tissue, suitability of the medical images for interpretation quantify suitability of the medical images for interpretation, and a data output device to advise a user of the quantified suitability of the medical images for interpretation.

The system may operate on a general-purpose computer or internet cloud-based system programmed to operate like the specific components disclosed.

The medical image evaluation method and system may provide a means to assess the sufficiency of visible tissue of interest in a medical image or ensemble of images and to predict missing tissue to improve interpretation of tissue(s) of interest or features within.

To aid in the segmentation and, or resolving the missing tissue, a first map which may be a olumetric tissue composition or thickness map may be generated. The first map may comprise first map values of tissue composition and, or thickness and, or density. The first map values may be representative of the tissue(s) of interest in the first medical image each with a first respective position in the medical image(s).

Obstructing or obscuring features may be resolved by one or more of patient medical data, shape measures, tissue composition, or location relative to image or tissue landmarks.

The medical image evaluation method may include resolving at least some of the missing tissue any portion of the tissue(s) of interest obstructed or obscured by superimposed or adjacent anatomical structures found from the image segmentation.

The medical image evaluation method may include a classification or rating of the medical images as either relatively more homogenous than heterogeneous or vice versa according to local volumetric tissue composition consistency throughout each of the medical images.

Local volumetric tissue composition consistency throughout each of the medical images may be derived from the volumetric tissue composition map. The consistency may be measured according to tissue composition statistical measures, or measures that evaluate changes in composition per location, Such measures may include spatial correlations and, or texture measures. The volumetric tissue composition heterogeneity may then be classified according to pre-defined thresholds of volumetric tissue composition consistency.

The medical image evaluation method may include selecting a subsequent step of the method according the classification or rating.

The subsequent step of analysis from medical images classified as relatively more homogenous than heterogenous may require summary statistics from any of the tissue regions or from the regions of tissue(s) of interest.

The subsequent analysis from medical images classified as relatively more heterogeneous than homogenous may include heterogeneous tissue in which there is sufficient complexity that additional useful information may be gleaned from further analysis. Such further analysis may include comparing image values along a segment profile through the images which are different views from one another. The values may be representative of the tissue(s) of interest in a first medical image versus second values representative of the tissue(s) of interest in the second medical image. Each of the values may be associated with a location in the associated image determined from a landmark in the medical images.

For the medical images classified as relatively more heterogeneous than homogeneous, the missing tissue may be resolved by assessing local volumetric tissue composition consistency, between medical images of different anatomical views, of tissue volume(s) per tissue type.

The medical image evaluation method may comprise registering or aligning an ensemble of the medical images and adapting the field of view to span all the tissues of interest and the surrounding region within the ensemble.

The medical image evaluation method may comprise making individual evaluations of each one of an ensemble of the medical images and combining the evaluations for collective analysis comparison to other anatomical views.

A suitability of the medical image(s) for interpretation may have a sensitivity to the missing tissue. The sensitivity may vary according to the purpose of the interpretation. The sensitivity may be defined by a variation in the suitability per a change in the missing tissue amount, type, and, or location. Suitability of the medical images for interpretation may be determined according to an estimate of a predicted sensitivity of the interpretation, as weighted by an amount, or location, or type of the missing tissue, and, or per change therein. The medical image evaluation method may comprise quantifying an uncertainty of the suitability of the medical image(s) for interpretation.

The uncertainty of the suitability may be quantified according to a likelihood that the estimate of the missing tissue amount, location, and, or type is correct or within a preselected range precision and, or accuracy.

The uncertainty of the suitability may be, or may also be, quantified according to an estimate of a relative amount of the missing tissue versus the tissue(s) of interest.

The uncertainty of the suitability may be, or may also be, quantified according to a prediction of influence on the suitability of a change in the missing tissue amount, type, and, or location.

The medical image evaluation method may include resolving the missing tissue by assessing first values representative of the tissue(s) of interest in the first medical image versus second values representative of the tissue(s) of interest in the second medical image. Each of the first values may be associated with a first location determined from a first landmark in the first medical image. Each of the second values may be associated with a second location determined from the same landmark in the second medical image. There may be a one-to-one correspondence between the location of each of the first values in the first medical image and the location of each of the second values in the second medical image.

To efficiently make the assessment of the first values versus the second values, both the first values and the second values may be collated and stored respective first and second lists. By choosing the first medical image to have a first anatomical view of the body portion and choosing the second medical image to have a second anatomical view of same body portion, the comparison of the first values to the second values may reveal the missing tissue. A location where tissue is missing may also be revealed.

Consequently, the system and method for evaluation of image quality provide vendor neutral evaluation via use of unprocessed images, where the pixel intensities may be transformed into values of a common or generic format for analysis.

The missing tissue may be missing because it is outside the field of view or because of an obstruction or obscuration. This may then be brought to the attention of a person responsible for making an interpretation of tissue of interest and, or features therein, and, or responsible for an assessment of whether there is missing tissue. The system and method for evaluation of image quality provide means to determine tissue sufficiency, tissue obstruction and obscuration.

To explain in more detail, the medical image evaluation method may comprise selecting from the medical images a first medical image having a first anatomical view of the body portion and a second medical image having a second anatomical view of the body portion. It may include generating a first map associating first map values representative of the tissue(s) of interest in the first medical image each with a first respective position in the first medical image. It may include also generating a second map associating second map values representative of the interesting tissue(s) in the second medical image with a second respective position in the second medical image.

The medical image evaluation method may comprise generating a first collated list of a first selection of the first map values by collating the first selection according to location of each first respective position with respect to a landmark in the first medical image. It may also comprise generating a second collated list of a second selection of the second map values by collating the second selection according to location of each second respective position with respect to the same landmark in the second medical image. The medical image evaluation method may comprise resolving the missing tissue by assessing the first collated list with respect to the second collated list.

The medical image evaluation method may comprise projecting on the first medical image a first line segment from the landmark, and projecting on the second medical image a second line segment from the landmark. The method may include collating the first collected list according to distance of the location of each first respective position along the first line segment from the landmark. The method may also include collating the second collected list according to distance of the location of each second respective position along the second line segment from the landmark.

The medical image evaluation method may comprise generating a first histogram comprising each first map value versus each associated first position in the first collated list. The method may also include generating a second histogram comprising each second map value versus each associated first position in the second collated list. The method may include assessing the first collated list with respect to the second collated list by using a histogram warping method to assess first histogram versus the second histogram.

In the medical image evaluation method, the histogram warping method may comprise dynamic time warping (DTW) or Boltzmann time warping (BTW).

The medical image evaluation method may comprise weighting each of the first map values in the first collated list according to the location of each first respective position with respect to the landmark. A higher weighting may be applied to the first map values associated with first respective positions which are closer to the landmark than to the first map values associated with first respective positions which are further from to the landmark.

The medical image evaluation method may comprise using at least one preselected descriptor of the body portion to identify and locate the landmark in the first and second medical images. The descriptor may be selected from a part of the body portion predicted or determined to be within the field of view. The descriptor may be selected from a part of the body portion predicted or determined to be outside of the field of view. A second descriptor predicted to be outside of the field of view may be used in conjunction with the pre-selected within the field of view.

The medical image evaluation method may comprise selecting the first anatomical view to be a CC view and the second anatomical view to be an MLO view or vice versa; or selecting the first anatomical view to be a PA view and the second anatomical view to be an LL view or vice versa.

Values of local thickness may be used. The medical image evaluation method may comprise generating the first map values as local thickness of the interesting tissue(s) in the first medical image. The method may include, or may also include, generating the second map values as local thickness of the interesting tissue(s) in the second medical image.

Values of local tissue composition may be used. The medical image evaluation method may comprise generating the first map values as local composition of the interesting tissue(s) in the first medical image. The method may include, or may also include, generating the second map values as local composition of the interesting tissue(s) in the second medical image.

The system and method for evaluation of image quality may provide for reference to tissue composition and tissue arrangement in the imaging FOV. This may provide for estimation of the adequacy of image quality, and measurements and other metrics derived from the image(s) for predictions of risk of disease.

The method may provide for prediction of an amount and type of one or more tissues of interest that may be missing from the field of view of medical image(s).

The method for prediction of missing tissue may include some or all of the following steps:

### Step 1

Image segmentation may be performed on one or more medical images of an organ or other body portion to delineate tissue(s) of interest from an adjacent region. The adjacent region may surround the tissue(s) of interest and be a surrounding region. The adjacent and, or surrounding region may include e.g. air and, or detector and, or adjacent body tissues) region(s).

Obscuring image features that may consist of physical objects (e.g., arms, shoulder, ear, hair, jewelry, implants, tubes, pacemaker, etc.), or image artefacts (e.g. skinfolds, dead pixels, collimator blades, etc.) comprise a special case of a ‘surrounding region’ that are to be identified, segmented and measured (volume/area).

One or more obscured region(s) may be segmented from the affected image, in addition to the tissue segmentation step.

### Step 2

A test may be made to ascertain whether any of the tissue of interest is ‘cut-off’ from the imaging FOV. If the tissue of interest is an organ, the test is for the organ ‘cut-off’. The test may use image segmentation(s) from step (1). A prediction may be made of the amount(s) (volume/area), location(s) and type(s) of tissue that is not visualised in the image, or image ensemble.

When prior clinical data is available, this may be used to improve the certainty of cut-off estimation and/or image ensemble identification.

If a sizeable proportion of the tissue of interest is predicted to be missing, further method steps may not be necessary due to the estimated high uncertainty of subsequent predictions that rely on adequate data for analysis.

a) A test may be made as to whether any of the tissue of interest extends outside of the FOV. The test may be by comparison of the FOV size and location with, for example the organ extent, with reference to relevant anatomical landmarks.

One means of doing the comparison of extent is a first identification of the organ boundary from the image segmentation and then a check for intersection of the organ boundary with the image edge. According to the anatomy of interest, some level of intersection may be anticipated and/or allowed in one or more image regions.

One or more thresholds may be applied to determine cases where the intersection(s) is deemed to be unacceptable. Such thresholds may be adaptive according to any available prior clinical data.

b) If an unacceptable level of organ tissue cut-off from a single view is found, a test may be made to determine whether the image belongs to an ensemble of images that may have been acquired to cover the extent of an organ that exceeds the size of the imaging FOV. In the case where only one view exists, it can be deemed that organ tissue was cut-off from the FOV. In the alternative case of an ensemble of images, these should be combined for further analysis of potential missing tissue. Comparison with prior clinical data can be used to confirm identification of image ensembles.

For the case where a single view of a large body section was acquired using an image ensemble to span the FOV, the individual images may be registered/aligned by methods known to those skilled in the art to estimate the total tissue imaged in that anatomical view.

In an alternative, the images comprising the ensemble are individually evaluated, but the measurements may be combined for collective analysis relative to other anatomical views.

### Step 3

One or more medical images of the organ tissues may be used to produce at least one thickness map, and at least one volumetric composition map that represents the local thickness and composition of the interesting tissue(s). The derivation of the thickness map(s) and volumetric composition map(s) rely on the image segmentations performed in Step (1). In this regard:

a) Any obscured image region may be excluded from the volumetric composition map using the segmentation(s) from step (1); and, or

b) for a case of an image ensemble representing a single view, volumetric tissue composition analysis may be made on the registered/aligned version of the image as derived in step (2); and, or

c) for a case of an image ensemble representing a single view, volumetric tissue composition analysis may be made on the individual constituent images the results of which are then registered/aligned for analysis.

In b) and c) location-dependent imaging parameters may be transformed to the aligned image framework for analysis

### Step 4

Evaluation of visualisation of tissue(s) in a medical image, or image ensemble, wherein labelled image segmentation(s), tissue thickness maps, volumetric composition maps and prior clinical data may be used alone or in combination to make a prediction of missing tissue(s) from one or more image views according to tissue composition.

a) The organ positioning in the imaging FOV may be assessed via geometrical descriptors of anatomical landmarks for the feature of interest relative to the relevant image-based or anatomy-based landmarks. This analysis primarily relies on the image segmentation(s) from Step (1). Measurements of individual geometrical positioning features may be used alone, or in combination, including in combination with non-geometrical features, for prediction of missing tissue.

b) For imaging exams where the patient anatomy is immobilised during imaging, the per-image and between-view quality and consistency of immobilisation may be assessed.

The quality and consistency of tissue immobilisation may be assessed for the present exam data with reference to descriptive data available from prior examinations of the same patient and same region of anatomy.

Alternatively, in the absence of prior examination data, the quality and consistency of tissue immobilisation may be assessed for the present exam data with reference to population-level statistics derived from representative sample data, selected to be appropriate for comparative analysis.

Comparative data selection may be done using methods known to those skilled in the art, such as natural language processing, image feature comparison, find-one-like-it analysis, etc. The patient and population data are likely to be matched for both patient characteristics (age, gender, height, weight, body mass index, ethnicity, organ size, tissue composition) and imaging modality (imaging system and immobilisation device characteristics), but cross-modality information may also be valuable for specific organ and tissue measurements.

c) Between-view consistency may be evaluated of tissue volume(s), per tissue type. Measurements of between view consistency may be used alone, or in combination, including in combination with non-volumetric features, for prediction of missing tissue.

The consistency of tissue volume(s) may be assessed for the present exam data with reference to descriptive data available from prior examinations of the same patient and same region of anatomy.

Alternatively, in the absence or prior examination data, the consistency of tissue volume(s) may be assessed for the present exam data with reference to population-level statistics derived from representative sample data, selected to be appropriate for comparative analysis.

Comparative data selection can be done using methods known to those skilled in the art as mentioned above for sub step b).

d) The potential combination of assessments of positioning geometry, immobilisation and tissue volume with tissue type-specific features for prediction of missing tissue will be based on the organ composition. In the event of an image, or image ensemble of an organ of relatively homogeneous composition as determined from Step (3), the above analysis (Step 4 a to c) may form the primary basis for a prediction of missing tissue from the FOV. For a more heterogeneous organ, this analysis may be secondary to measurements specific to the internal organ tissues.

In a case of an image ensemble, the assessment may be performed on the aligned images.

In an alternative case of an image ensemble, the assessment may be performed on the individual images, but with an overall assessment made for the ensemble that combines the measurements from the individual images.

e) For an image, or image ensemble of an organ of relatively heterogeneous composition as determined from Step (3), measurements of one or more organ tissue types and their locations may be used to predict the amount(s) and location(s) of tissue that is missing from the FOV. One or more tissue analysis methods may be used, individually, or in combination to derive the prediction(s).

(i) Morphological measurements may be made per organ tissue type from volumetric composition maps. An example morphological measurement involves thresholding the volumetric composition map to either a fixed or adaptive threshold. It involves applying morphometric measurements to the tissue of interest within the threshold, such as measurements of the shape and sizes of threshold identified areas of the tissue of interest within the threshold and/or perimeters of tissue regions within or outside of the threshold. This may identify intersections of one or more tissue regions of a given tissue type with one or more image boundaries.

(ii) Tissue composition in an image or image ensemble may be calculated along a trajectory between anatomical or image landmarks. For example, the average tissue composition may be calculated over a line segment between landmarks. The line segment may be a moving line segment. The trajectory of the line segment trajectory may be defined according to the orientation of the anatomical view with reference to the anatomy and/or image boundaries. The output of the tissue composition along one or more trajectories may be used to construct a ‘distance histogram’. In the distance histogram the averaged tissue composition measurements may be arranged in order of the distance from the landmark of interest.

Two or more distance histograms from separate anatomical views can be matched using dynamic time warping (DTW), Boltzmann time warping (BTW) or a similar histogram warping method. Weighting, or penalties, may be applied to the histogram according to the location relative to the landmark.

Any non-matching bins at the farthest location from a landmark may not be penalized given high uncertainty, whereas a high penalty could be placed on locations near a given landmark where uncertainty is lower. Any non-matched section(s) of the distance histogram in one anatomical view could be used to estimate the amount of tissue missing from the comparison anatomical view.

(iii) The image, image ensemble, or cropped portion of the image(s) may be used as a reference against which comparative analysis with a predicted and/or simulated image is made. The predicted image may be a combination of the original image and a simulated portion, or an entirely simulated image.

For example, a portion of the original image or image ensemble can be input to a Generative Adversarial Network (GAN) that synthesises via out-painting, the remaining image portion. The GAN would be pre-trained using a large number of representative images estimated to have minimal missing tissue such that the GAN would typically synthesise an image with all tissue in view.

Given an image with insufficient parenchymal disk, GAN may out-paint the missing tissue. If the out-painted image is significantly different from the real image, it may indicate a cut-off.

A comparison between the original image and the out-painted image may be made to predict missing tissue. If the synthesised image is identical, or nearly identical, to the original image according to metrics known to those skilled in the art, such as a DICE coefficient, no missing tissue is predicted. If there is a significant difference between the images, then the amount(s) of tissue(s) predicted to be missing according to the synthesised image may be used as the method prediction.

f) Alternatively, to or in conjunction with Step 4e, methods (i) to (iii) may be applied to other common image formats, such as the DICOM standard ‘For Presentation’ or ‘For Processing’, or normalised versions of either of these formats, according to normalisation methods known to those skilled in the art. The data may be stored in two dimensional formats or in three dimensions as volumetric data.

### Step 5

The prediction(s) of missing tissue(s) for each image or image ensemble from Step 4 may be used to generate clinical decision support data, which may include data intended to inform one or more of the applications of image quality assessment, tissue quantification, and interpretation.

a) The results of predictive evaluation of visualisation of tissue(s) in a medical image, or image ensemble, as estimated with reference to tissue composition, may be used to determine the likelihood of improved image quality via image retake. This prediction may be made by comparing the amount(s) of organ tissue(s) and their location relative to the image field of view that are estimated to be missing according to available reference data. This data may include one or more of: prior exam data from the same patient; current patient biometric data that may explain positioning difficulties; performance measures of the medical imaging technologist per view and per anatomical landmark; interpreting physician preferences; and image acquisition technical parameters descriptive statistical data.

The image acquisition technical parameters descriptive statistical data may include: data grouped according to patient characteristics. These may include imaging equipment characteristics and relationships between particular image quality deficiencies and the likelihood of improved tissue visualisation upon their correction.

If the amount of missing tissue is above a certain threshold, which may be fixed or adaptive, then the image would be identified as being likely to benefit from repeat and this information would be made available to the user.

b) An estimate may be made of the uncertainty of tissue quantification for one or more tissues of interest using predictive evaluation of visualisation of tissue(s) in a medical image, or image ensemble, as estimated with reference to tissue composition measured from each view available from a patient exam, and any available prior exam data.

The uncertainty in interpretation may be weighted according to the volume of tissue that is predicted to be missing from the view(s).

Preferably prior clinical imaging data from the same organ is used for reference comparison. If a larger-than-expected change in tissue quantification is found, especially as measured from a single view, then this would represent a high uncertainty, whereas a difference that is within an acceptable range would represent a low uncertainty, such that the results could be applied for clinical use with high confidence.

If no prior clinical data is available for the patient, then reference population-level data may be used to predict expected changes. This population-level data may be preferred to be patient-specific in that the patient characteristics are matched on various criteria to reference patient data. For example, machine learning classification may be used to efficiently identify appropriate reference patient data.

c) The tissue quantification uncertainty from (b) may be used to estimate the uncertainty in the prediction of the risk of disease for any predictive measures that are dependent on tissue quantification. Uncertainty may be assigned to disease risk prediction model inputs, both quantitative, and any categorical inputs.

d) The tissue quantification uncertainty from Step 5 (b) may be used to estimate the uncertainty in interpretation. The interpretation may be via any of Computer Aided Detection, AI-based detection algorithms, or by one or more human readers.

The uncertainty in interpretation may be weighted according to the volume of tissue that is predicted to be missing from the view(s).

The uncertainty in interpretation may account for the amount of tissue predicted to be missing from view. The uncertainty may account for the predicted location(s) of tissue estimated to be missing from the FOV. This estimate may then be weighted according to statistical data on the frequency of disease that arises at the location(s) predicted to be out of the FOV.

The individual measures may be combined in a multi-parametric model to develop a single score for tissue visualisation that accounts for patient characteristics, tissue positioning, and tissue immobilisation. Multi-parametric modelling could be done by means of an approach such as logistic regression or using machine-learning algorithms to optimize the value of the score for application in, for example, an image repeat decision, weighting of CAD algorithm certainty and uncertainty of prediction of risk of disease.

The invention will now be described, by way of example only, with reference to the accompanying figures in which:

### BRIEF DESCRIPTION OF THE FIGURES

FIG. 1 shows an overall workflow of method for prediction of missing tissue in medical imaging;

FIG. 2 shows a Generative Adversarial Network (GAN)-based image out-painting;

FIG. 3 shows axes on a craniocaudal (CC) projection view mammographic image;

FIG. 4 shows axes on a mediolateral oblique (MLO) projection view of the same breast shown in FIG. 3;

FIG. 5 shows a ‘distance histogram’ of average tissue composition measurements corresponding to the CC projection view of FIG. 3 along the axis segment over the tissue;

FIG. 6 shows a ‘distance histogram’ of average tissue composition measurements corresponding to the MLO projection view of FIG. 4 along the axis segment over the tissue; and

FIG. 7 shows superposed the distance histogram of the CC projection view of FIG. 5 and the MLO projection view of FIG. 6.

### DETAILED DESCRIPTION OF THE INVENTION

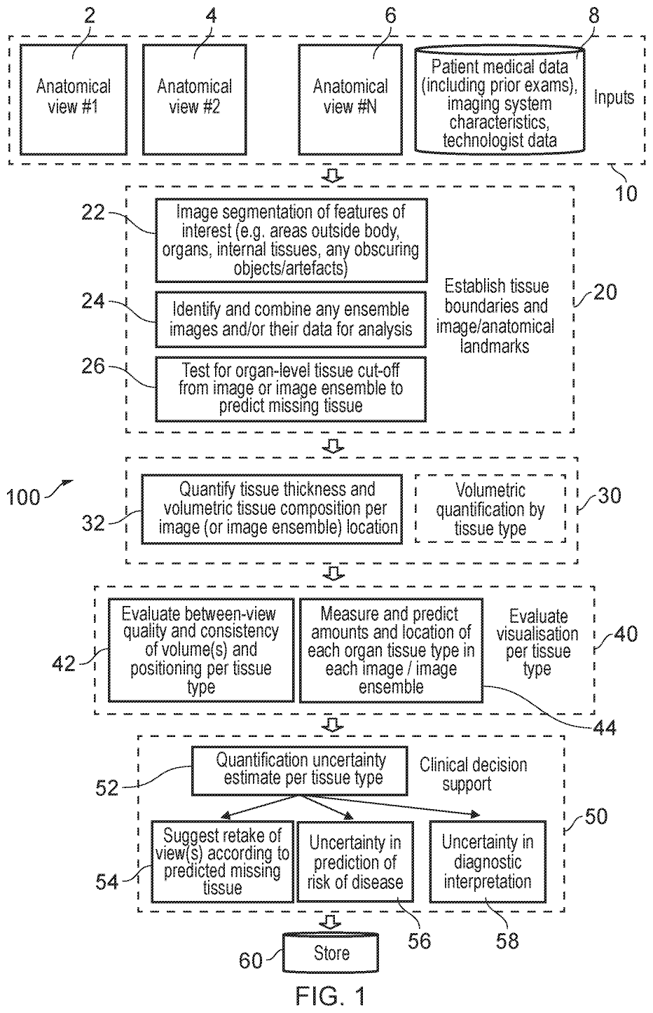

An overall workflow of method for prediction of missing tissue in medical imaging is illustrated by FIG. 1. There is a medical image evaluation method 100 comprising acquiring data of medical images 2, 4, 6. The data of medical images 2, 4, 6 includes quantitative location coordinates of pixels in the medical images. The data includes information indicative of tissue composition, thickness, and density at the location of each pixel. The data of medical images 2, 4, 6 also includes patient medical data 8 including prior exams, imaging system characteristics, and technologist data. The data of medical images 2, 4, 6 including patient medical data 8 are method inputs 10.

Each of the medical images 2, 4, 6 have an anatomical view, for example a CC view, MLO view, PA view and/or MLO view. Each medical image 2, 4, 6 has a different type of anatomical view than the others, or each medical image 2, 4, 6 has the same type of anatomical view as the others, or some of the medical image 2, 4, 6 have a different type of anatomical view than the others while some of the medical images share the same type of anatomical view.

The medical image evaluation method 100 performs an image segmentation 22 on one or more medical image(s) of a body portion to delineate tissue(s) of interest from a surrounding region within a field of view. Segmentation makes apparent regions within the field of view including: regions outside of the body portion, organs, and artifacts which may comprise the body portion or obstruct or obscure tissue(s) of interest inside or outside of the body portion. Tissue within the body portion is internal tissue which includes the organs, tissue(s) of interest, and artifacts.

The medical image evaluation method 100 performs an identification and combination step 24 by combining any ensemble of several of the medical images 2, 4, 6 and/or their patient medical data 10 for analysis. This depends on if, for example, all the medical images 2, 4, 6 have the same or nearly the same field of view or were acquired at various times and are to be compared or combined.

A test for organ-level tissue cut-off 26 is performed. The test for organ-level tissue cut-off assesses whether any of the organs or tissue(s) of interest extend beyond the field of view of any of the medical image(s), or field of view of an ensemble of the medial images 2, 4, 6. The three steps of image segmentation 22, identification and combination of ensemble images 24, and tests for organ-level tissue cut-off 26 together establish tissue boundaries, image landmarks, and anatomical landmarks. Resolving any missing tissue which is any portion of the tissue(s) of interest missing from the image segmentation is aided by a step of establishing the tissue boundaries and image landmarks and anatomical landmarks 20. Any portion of the tissue boundaries or image/anatomical view that are found to be outside of the field of view or obscured or obstructed within the field of view is resolved to be missing tissue when it is portion of the tissue(s) of interest missing from the image segmentation.

A step of volumetric quantification by tissue type 30 is done for the various segmented regions. Volumetric quantification includes quantification of tissue thickness and tissue composition per image, or per image ensemble 32.

For each one of the medical images, quantification of tissue thickness may be aided by generating a corresponding map of values as local thickness of the interesting tissue(s) in that medical image. This type of map is a tissue thickness map. In a step to evaluate visualisation per tissue type 40 at least a first and a second medical image are used. The first medical image has a first anatomical view of the body portion. The second medical image has a second anatomical view of the body portion. An anatomical view is for example a CC view, an MLO view, a PA view, or an LL view, or another anatomical view.

Either the first medical image or the second medical image may be generic medical image which is not of the patient in question. When only one view of the patient in question is available, reference data, for example relevant population statistics, and, or the generic medical image may suffice in place of the second image,

The first anatomical view is different than the second anatomical view so that a step of the method is to evaluate between-view quality and consistency of volumes and positioning per tissue type, step 42. It is possible to measure and/or predict amount and location of each organ tissue type or tissue of interest in each of the medical images and/or ensemble of the medical images by step of the method 44.

It may be advantageous to compare the medical images when they are relatively more heterogeneous than homogeneous in composition or density of the tissue(s) of interest. A composition map or density map may aid evaluation and comparsion. An amount of tissue of interest that is missing tissue is assessed for each of the medical images and each anatomical view. The assessment is done by evaluating and comparing local tissue composition, thickness, and, or density at corresponding locations in the first and second views.

The method provides information on the medical images as clinical decision support 50. The amount of missing tissue in the body portion of a particular medical image or ensemble of the medical images informs an estimate of uncertainty in using that medical image for prediction of risk of disease 56 or an indication of an etiology or as an indicator or predictor of a disease 56. Where the uncertainty is above a preselected level, careful review is suggested, and an image retake may be considered 53.

The method is implemented by a medical image evaluation system which has a data storage device for the method to implement a step to store 60 the information from the steps 10, 20, 30, 40, 50 to evaluate the image(s) quality.

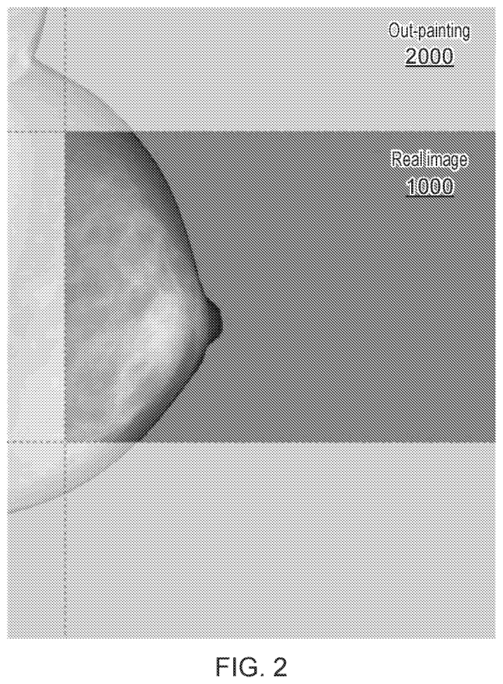

FIG. 2 shows an out-painting 2000 of an image of a body portion which is a breast. The real image 1000 is also shown.

FIG. 3 shows a first medical image of a first anatomical view of a body portion. The first anatomical view is a CC view mammogram. The body portion is a breast. There is a first line segment 202 straight back from the nipple. The first line segment 202 is established between the nipple and chest side wall 206 in the CC view. The first line segment 202 is perpendicular to a first tangent line 204 which is tangent to the skin surface at the nipple. The nipple and chest side wall are anatomical landmarks of the body portion. The skin surface and chest side wall are boundaries of the body portion.

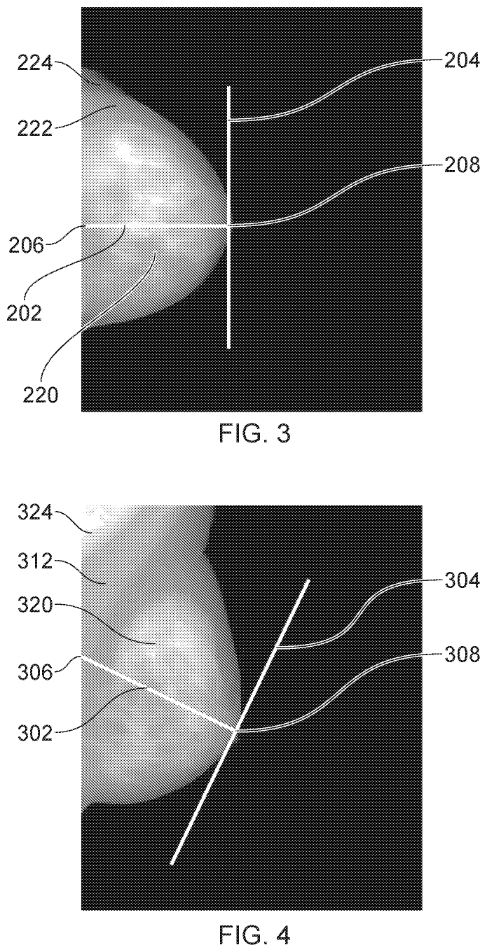

FIG. 4 shows a second medical image of a second anatomical view of the same body portion that is the same breast. The second anatomical view is an MLO view. There is a second line segment 301 straight back from the nipple 308. The second line segment 302 is established between the nipple and chest wall 306 at the pectoralis muscle in the MLO view. The second line segment 302 is perpendicular to a second tangent line 304 tangent to the skin surface at the nipple in the MLO view.

In the CC view in FIG. 3 are three tissues of interest 220, 222, 224. The three tissues of interest 220, 222, 224 are distinguished by segmentation. In the MLO view of FIG. 4 are three corresponding tissues of interest 320, 312, 324 which are also distinguished by segmentation.

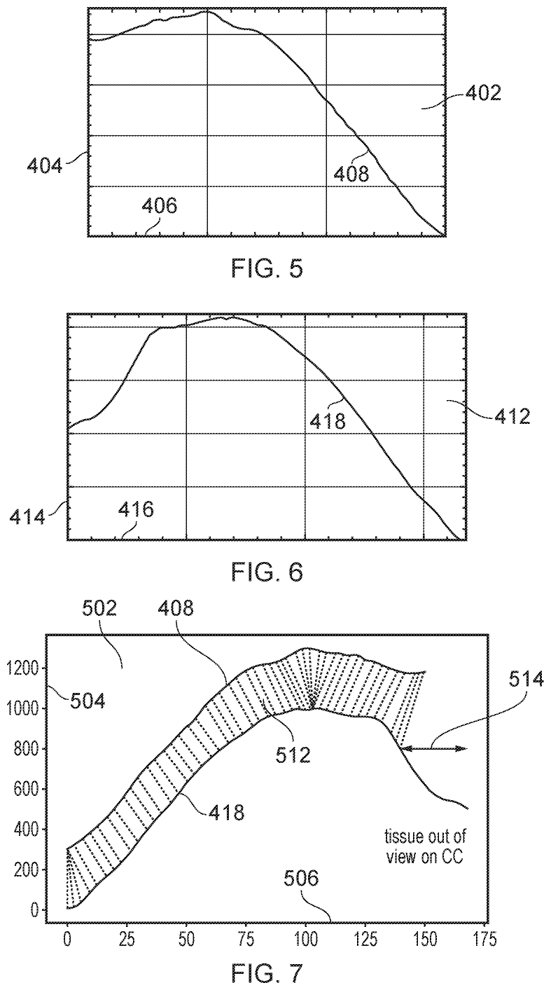

FIG. 5 is a first chart (402) and shows a first distance histogram for the CC view of the first medical image in FIG. 3. The first distance histogram has a vertical axis 404 for values of the tissues of interest in the CC view. It also has a horizontal axis 406 for distances from an anatomical landmark.

FIG. 5 shows a first values line 408 on the first distance histogram. Values of the tissues of interest at positions located along the first line segment 202 of the CC view are plotted along the first values line 408. The horizontal axis 406 shows the distance along the first line segment 202 from the nipple which is the anatomical landmark. The values are plotted along the first values line 408 in order of the distance from the landmark of the location of the position on the second line segment 202. The vertical axis 404 shows a value or average value of the local tissue composition or local tissue density.

FIG. 6 is a second chart (412) and shows a second values line 418 on a second distance histogram. The second distance histogram plots values from the MLO view of the second medical image in FIG. 4.

In FIG. 6 values of the tissues of interest at positions located along the second line segment 302 of the MLO view are plotted along the second values line 418. The horizontal axis 416 shows the distance along the second line segment 302 from the nipple which is the anatomical landmark. The values are plotted along the second values line 418 in order of the distance from the landmark of the location of the position on the second line segment 302. The vertical axis 414 shows a value or average value of the local tissue composition or local tissue density.

The values plotted by the first values line 408 are the same kind as plotted by the second values line 418. For example, both the first values line 408 and the second values line 418 plot values of local tissue composition, or both plot tissue density.

FIG. 7 is third chart (502) and shows histogram matching between CC view mammographic image of FIG. 3 and the MLO mammographic image view of FIG. 4. Each value per position along the first values line 408 is assessed with the value per respective position along the second values line 418 by using a histogram warping method, image registration method, or other method to assess first histogram versus the second histogram. The vertical axis 504 shows the values from this comparison at each distance value along the horizontal axis 506.

The histogram warping method comprises dynamic time warping (DTW) or Boltzmann time warping (BTW) or another warping technique, image registration method, or other method of comparison. There is a non-matched section 514 of the distance histogram from the anatomical view could be used to estimate the amount of tissue missing from the comparison anatomical view.

The invention has been described by way of examples to be considered as illustrative of the principles of the invention. Since modifications and changes will readily occur to those skilled in the art, it is not desired to limit the invention to the exact construction and operation shown and described. Accordingly, all suitable modifications and changes may be resorted to, falling within the scope of the invention and claims.

1. A medical image evaluation method comprising:
acquiring data of one or more medical image(s) of a body portion;
performing an image segmentation on the medical image(s) to delineate tissue(s) of interest from a surrounding region within a field of view;
resolving any missing tissue which is any portion of the tissue(s) of interest missing from the image segmentation; and
resolving, from the missing tissue, suitability of the medical image(s) for interpretation.

2. A medical image evaluation method according to claim 1 comprising resolving as at least some of the missing tissue any portion of the tissue(s) of interest obstructed or obscured by superimposed or adjacent anatomical structures found from the image segmentation.

3. A medical image evaluation method according to claim 1 comprising a classification, or rating, of the medical images as either relatively more homogenous than heterogeneous or vice versa according to local volumetric tissue composition consistency throughout each of the medical images, and selecting a subsequent step according to the classification or rating.

4. A medical image evaluation method according to claim 3 wherein the subsequent step of analysis from medical images classified as relatively more homogenous than heterogenous requires summary statistics from any of the tissue regions or from the regions of tissue(s) of interest.

5. A medical image evaluation method according to claim 3 wherein the subsequent step of analysis from medical images classified as relatively more heterogeneous than homogeneous includes comparing image values along a segment profile through the images which are different views from one another.

6. A medical image evaluation method according to claim 1 comprising registering or aligning an ensemble of the medical images and adapting the field of view to span all the tissues of interest and the surrounding region within the ensemble.

7. A medical image evaluation method according to claim 1 comprising making individual evaluations of each one of an ensemble of the medical images and combining the evaluations for collective analysis comparison to other anatomical views.

8. A medical image evaluation method according to claim 1 comprising quantifying an uncertainty of the suitability of the medical image(s) for interpretation according to a likelihood that an estimate of an amount or location or type of the missing are correct versus the tissue(s) of interest.

9. A medical image evaluation method according to claim 1 comprising determining the suitability according to an estimate of a predicted sensitivity of the interpretation, as weighted by an amount, or location, or type of the missing tissue.

10. A medical image evaluation method according to claim 1 comprising
selecting from the medical images a first medical image having a first anatomical view of the body portion and a second medical image having a second anatomical view of the body portion;
generating a first map associating first map values representative of the tissue(s) of interest in the first medical image each with a first respective position in the first medical image, and
generating a second map associating second map values representative of the interesting tissue(s) in the second medical image with a second respective position in the second medical image;
generating a first collated list of a first selection of the first map values by collating the first selection according to location of each first respective position with respect to a landmark in the first medical image, and
generating a second collated list of a second selection of the second map values by collating the second selection according to location of each second respective position with respect to the same landmark in the second medical image; and
resolving the missing tissue by assessing the first collated list with respect to the second collated list.

11. A medical image evaluation method according to claim 10 comprising projecting on the first medical image a first line segment from the landmark, and projecting on the second medical image a second line segment from the landmark;
collating the first collected list according to distance of the location of each first respective position along the first line segment from the landmark, and
collating the second collected list according to distance of the location of each second respective position along the second line segment from the landmark.

12. A medical image evaluation method according to claim 10 comprising
generating a first histogram comprising each first map value versus each associated first position in the first collated list, and
generating a second histogram comprising each second map value versus each associated first position in the second collated list; and
assessing the first collated list with respect to the second collated list by using a histogram warping method to assess first histogram versus the second histogram.

13. A medical image evaluation method according to claim 12 wherein the histogram warping method comprises dynamic time warping (DTW) or Boltzmann time warping (BTW).

14. A medical image evaluation method according to claim 10 comprising weighting each of the first map values in the first collated list according to the location of each first respective position with respect to the landmark.

15. A medical image evaluation method according to claim 14 comprising applying higher weighting to the first map values associated with first respective positions which are closer to the landmark than to the first map values associated with first respective positions which are further from to the landmark.

16. A medical image evaluation method according to claim 10 comprising using at least one preselected descriptor of the body portion to identify and locate the landmark in the first and second medical images.

17. A medical image evaluation method according to claim 10 comprising preselecting the descriptor from a part of the body portion predicted to be within the field of view.

18. A medical image evaluation method according to claim 10 comprising preselecting the descriptor from a part of the body portion predicted to be outside of the field of view.

19. A medical image evaluation method according to claim 10 comprising selecting the first anatomical view to be a CC view and the second anatomical view to be an MLO view or vice versa; or selecting the first anatomical view to be a PA view and the second anatomical view to be an LL view or vice versa.

20. A medical image evaluation method according to claim 10 comprising generating the first map values as local thickness of the interesting tissue(s) in the first medical image, and
generating the second map values as local thickness of the interesting tissue(s) in the second medical image.

21. A medical image evaluation method according to claim 10 comprising
generating the first map values as local composition of the interesting tissue(s) in the first medical image, and
generating the second map values as local composition of the interesting tissue(s) in the second medical image.

22. A medical image evaluation system comprising:
a data input device to acquire data of medical images;
a data processor to perform an image segmentation on one or more of the medical image(s) of a body portion to delineate tissue(s) of interest from a surrounding region within a field of view;
the data processor to resolve any missing tissue which is any portion of the tissue(s) of interest missing from the image segmentation;
the data processor to resolve, from the missing tissue, suitability of the medical images for interpretation; and
a data output device to advise a user of the quantified suitability of the medical images for interpretation.
